(19) United States
(12) Patent Application Publication
(10) Pub. No.: US 2026/0289362 A1
(43) Pub. Date: Sep. 24, 2026

(54) Autoregressive Model Fitting for Time Series Anomaly Detection

(71) Applicant: FANUC CORPORATION, Yamanashi (JP)

(72) Inventors: Yujiao Cheng, Sunnyvale, CA (US); Tetsuaki Kato, Union City, CA (US)

(21) Appl. No.: 19/083,846

(22) Filed: Mar. 19, 2025

(51) Int. Cl. G06N 7/08

(52) U.S. Cl. CPC G06N 7/08

(57) ABSTRACT

A method and system for anomaly detection from time-series input data. Time-series data for joint parameters of a robot operation is periodically collected over the robot's service interval. For each data collection event, the time-series data is segmented to retain only a range of interest where the joint speed is zero. Autoregressive model fitting is performed on the retained time-series data using a low-order model. The measured parameter data is then compared to the model-fitted data, resulting in an error value at each time-series data point. An error metric is computed from the time-series error values, and an alarm is issued when the error metric exceeds a predefined threshold. The error metric provides a reliable early indication of initial stages of joint degradation—far earlier than the joint exhibits any other signs of impending problems.

### BACKGROUND

### Field

The present disclosure relates generally to a method for anomaly detection in time-series data and, more particularly, to a method for anomaly detection which periodically collects time-series data for parameters of a machine operation, segments the time-series data to a range of interest, performs an autoregressive model fitting using a low-order model, compares the measured parameter data to the fitted data, and issues an alarm when the fitting error exceeds a threshold.

### Discussion of the Related Art

Anomaly detection is a broad class of computational analysis where some type of input data sample is analyzed to determine whether the data sample represents a normal condition or an anomalous condition. The data sample may be an image of a part, in which case the analysis determines whether the part is normal or an anomaly, or the data sample may be time-series data from an operation, in which case the analysis determines whether the operating conditions are normal or an anomaly.

Industrial robots are used in many types of operations-including processing applications such as laser welding and painting, and material movement applications such as picking parts off of a conveyor and placing them in a secondary location such as a compartmented container. In many of these applications, the robots repeatedly perform similar motions, but these motions may not be exactly the same from one movement trajectory to the next. Because robots often perform a variety of operations which are similar but not exactly the same, it is not possible to detect anomalies by simply evaluating parameter data and looking for any small change in a value from one operation to the next. This is because fairly minor-looking changes in a tool center point trajectory or acceleration profile can have a large effect on joint loads and accelerations, which renders invalid a direct comparison of time-series parameter data from one operation to another.

Modern robots include sensory devices and data analysis algorithms which are employed to determine if and when a robot component has failed or is in a degraded condition. Oftentimes, however, these detection devices and software systems can only detect a problem after the problem has developed to a significant extent.

In view of the circumstances described above, improved methods are needed for anomaly detection from time-series input data where initial stages of performance degradation may be difficult to detect using existing techniques.

### SUMMARY

The following disclosure describes a method and system for anomaly detection from time-series input data. Time-series data for joint parameters of a robot operation is periodically collected over the robot's service interval. For each data collection event, the time-series data is segmented to retain only a range of interest where the joint speed is zero. Autoregressive model fitting is performed on the retained time-series data using a low-order model. The measured parameter data is then compared to the model-fitted data, resulting in an error value at each time-series data point. An error metric is computed from the time-series error values, and an alarm is issued when the error metric exceeds a predefined threshold. The error metric provides a reliable early indication of initial stages of joint degradation-far earlier than the joint exhibits any other signs of impending problems.

Additional features of the present disclosure will become apparent from the following description and appended claims, taken in conjunction with the accompanying drawings.

### BRIEF DESCRIPTION OF THE DRAWINGS

FIG. 1 is an illustration of an industrial robot performing a set of repetitive tasks, along with a representation of data collected during the robotic operations, as used in the techniques of the present disclosure;

FIG. 2 is a block diagram illustration of an anomaly detection system which uses segmentation of time-series data to a select a range of interest, and autoregressive model fitting to identify anomalous data, according to embodiments of the present disclosure;

FIG. 3 is a graph of robot joint torque command data versus time for a selected time segment of an operation exhibiting normal conditions and robot joint torque command data for a selected time segment of an operation exhibiting anomalous conditions, according to embodiments of the present disclosure;

FIG. 4 is a set of graphs plotting measured torque command data and autoregressive model fitted data versus time, along with the corresponding error data versus time, for both normal and anomaly conditions of a robot, according to embodiments of the present disclosure; and

FIG. 5 is a flowchart diagram of a method for anomaly detection in time-series data from a machine operation, including using autoregressive model fitting applied to segmented data along with subsequent analytic computations, according to embodiments of the present disclosure.

### DETAILED DESCRIPTION OF THE EMBODIMENTS

The following discussion of the embodiments of the disclosure directed to a method for anomaly detection in time-series data using autoregressive model fitting is merely exemplary in nature, and is in no way intended to limit the disclosed techniques or their applications or uses.

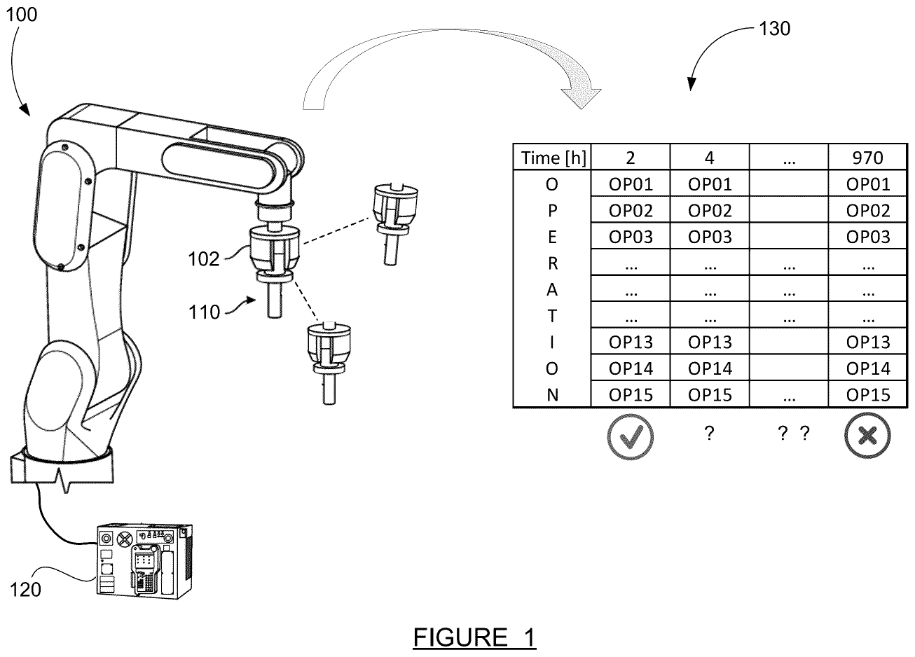

FIG. 1 is an illustration of an industrial robot performing a set of repetitive tasks, along with a representation of data collected during the robotic operations, as used in the techniques of the present disclosure. A robot 100 is a typical multi-axis articulated robot as commonly used in industrial applications. The robot 100 has a set of arm links interconnected by rotational joints with joint motors-such as servo motors with harmonic drive gearing. The operation depicted in FIG. 1 is a part movement or placement application, where the robot 100 is fitted with a gripper 102 which grasps a workpiece 110 and moves the workpiece 110 from one location to another. The workpiece 110 is shown in other locations proximal the robot tool center, simply to illustrate the workpiece movement to multiple locations. A controller 120 controls motion of the robot 100 in a known manner, including issuing joint motion commands designed to move the tool center point (gripper 102) through a prescribed motion profile.

In a scenario discussed throughout the present disclosure, the robot 100 repetitively performs a set of similar operations. These operations could include moving the workpiece 110 from a fixed starting location to various compartments of a container for shipping, where each trajectory is slightly different depending on the spatial location of the compartment into which the workpiece is placed. Another example would be where the spatial trajectory of all of the operations is exactly the same, but the velocity and acceleration profile is different from one operation to the next-such as if the time allotted to complete each operation is different. The robot could be performing other types of operations as well-such as spray painting or spot welding, including performing several different tasks on each workpiece. In each of these examples, anomaly detection in the time-series data is challenging because although the trajectories may be similar, the exact values of joint torques and motions are not the same from one operation to the next.

In addition to controlling the robot 100, the controller 120 also collects data during robotic operations. A table 130 depicts the data collection framework for the scenario described above. The robot 100 repetitively performs a set of 15 operations, labeled as OP01 through OP15. A time-series data file is recorded for each of the 15 operations once in every two-hour time window, as an example. It is known that the robot is in good working order at the first data collection window (i.e., t=2 hours); for example, the robot 100 may have just been placed in service when new or immediately after a service overhaul. The known good status of the robot 100 is indicated by the checkmark at the bottom of the first column of the table 130. Many hundreds of working hours later (e.g., at t=970 hours), a robot sensor indicates a malfunction in a component-such as a harmonic drive component in a high-load joint. This detected malfunction triggers a shutdown of the robot 100 for repairs. The detected component failure is indicated by the circled x at the bottom of the last column of the table 130.

Analysis of robotic components after a malfunction indicate that the component which malfunctioned often undergoes a period of degradation before the ultimate malfunction. Unfortunately, however, this period of degradation is difficult or impossible to detect using traditional robotic performance sensors and even existing anomaly detection methodologies. The techniques of the present disclosure have been developed to provide advanced detection of anomalies in earlier stages of the onset of degradation, so that repairs may be made before other components in the robot are damaged or the performance of the robotic operations is adversely affected.

FIG. 1 depicts data collection for a multi-axis industrial robot, examples of which are discussed throughout the present disclosure. However, the techniques of the present disclosure are applicable to time-series data from any type of machine—not just industrial robots. In addition, the time-series data collection frequency, numbers of time steps, etc., in the examples discussed herein are merely exemplary.

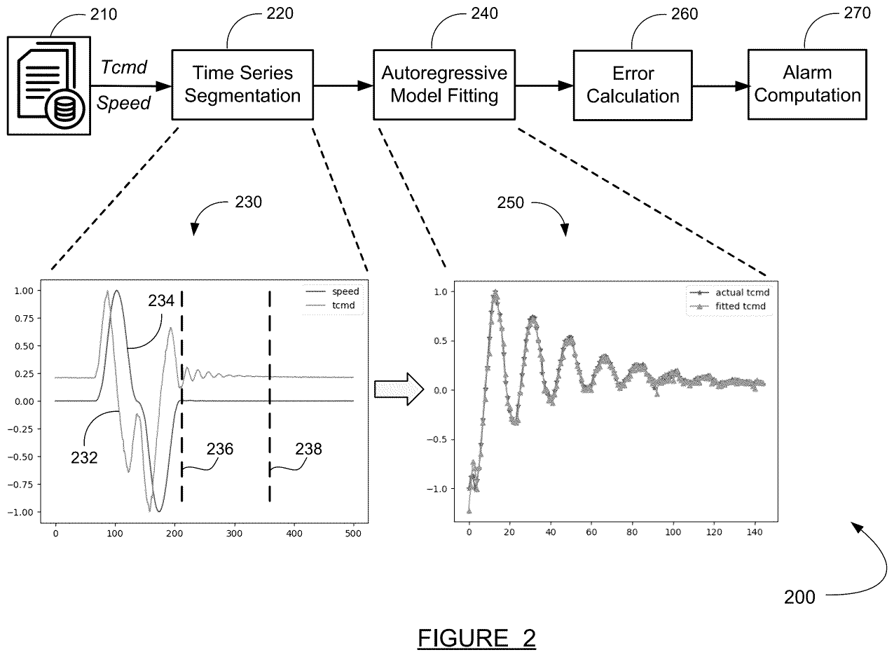

FIG. 2 is a block diagram illustration 200 of an anomaly detection system which uses segmentation of time-series data to a select a range of interest, and autoregressive model fitting to identify anomalous data, according to embodiments of the present disclosure. In some embodiments, the system depicted in the block diagram 200 executes on the machine controller-such as the controller 120 of FIG. 1. In other embodiments, the anomaly detection system executes on a separate computer in communication with the controller.

Input data is provided in a block 210. In a typical embodiment for anomaly detection in an articulated robot as shown in FIG. 1, the input data includes torque command data and joint speed data for a joint of the robot. The torque command is the commanded value of motor torque for a particular joint as provided by the robot controller, and the joint speed is the joint rotational velocity as measured by a sensor (such as a joint encoder providing position data which is differentiated to obtain velocity). The following discussion will describe the anomaly detection methodology applied to data from one robot joint. It is to be understood of course that data can be collected from other robot joints and the anomaly detection method applied to those input data sets as well. The input data is time-series data covering a robot operation at one of the measurement windows, as explained with respect to FIG. 1. In a typical example, the input data is collected for the entire time it takes to perform the operation, which is several seconds, and the time-series input data includes several hundred time steps of measured data for each of the torque command and joint speed.

In a block 220, the time-series input data is segmented to retain only a range of interest for further analysis. This process is illustrated in a graph 230 below the block 220. The graph 230 includes a torque command data trace 232 and a joint speed data trace 234. The data traces 232 and 234 are plots of the time-series input data for the torque command and the joint speed, respectively, versus time. In the case of robot joint data, the joint speed input data is used only for data segmentation. Specifically, the segment or range of interest begins when the joint speed (rotational velocity) settles out to zero. This happens at a time indicated by a vertical dashed line 236, which represents the beginning of the data segment or range of interest. It can be seen in the graph 230 that there are still residual torque command signals even after the joint velocity is essentially zero. The residual torque command signals dissipate as the robot's dynamics dampen out. After that, there is nothing of interest happening in the torque command data; this happens at a time indicated by a vertical dashed line 238, which represents the end of the data segment or range of interest.

Once the time-series data has been segmented as described above, only the torque command data in the selected time segment is used for further processing. The other torque command data (before and after the selected time segment), and the joint speed data, are not used for further processing by way of autoregressive model fitting. In validation trials of the presently disclosed methodology, it has been demonstrated that the torque command data in the data segment or range of interest described above (after joint velocity drops to zero and while residual torque commands are still present) is the most effective predictor of impending defects.

At a block 240, the autoregressive model fitting is performed on the torque command data in the selected time segment. An autoregressive model is a representation of a process, and can be used to describe certain time-varying processes. The autoregressive model specifies that the output variable depends linearly on its own previous values and on a stochastic (randomly varying) term. The autoregressive model can be defined generally as follows:

$$y [ k ] = {a}_{1} y [ k - 1 ] + {a}_{2} y [ k - 2 ] + … + {a}_{m} y [ k - m ] + e \qquad ( 1 )$$

Where y is the variable in the time-series data set (i.e., the torque command data), k is the time step (and [k−1] is the previous time step, etc.), a₁ (and a₂ . . . aₘ) are learned coefficients of the autoregressive model, e is the stochastic “error” term, and m is the order of the autoregressive model.

The autoregressive model is computed in a calculation using the entire time-series data set for the selected time segment. In a typical example of the robotic operation discussed earlier, the selected time segment might include 150 data points. In developing the presently disclosed methodology, various values of the model order m were evaluated, and it was concluded that an order of m=2 provided the best results. Thus, for a second-order (m=2) autoregressive model, a set of equations can be written which follow a pattern as indicated below:

$$y [ 3 ] = {a}_{1} y [ 2 ] + {a}_{2} y [ 1 ] + e \qquad ( 2 )$$

$$y [ 4 ] = {a}_{1} y [ 3 ] + {a}_{2} y [ 2 ] + e \qquad ( 3 )$$

$$… … …$$

$$y [ 15 \; 0 ] = {a}_{1} y [ 149 ] + {a}_{2} y [ 148 ] + e \qquad ( 4 )$$

Where the value of e (the stochastic “error” term) is different for each time step, within a random distribution, according to autoregressive model fitting theory.

Using Equations (2)-(4) (and all of the 140+ other equations in the set), a least squares regression can be formulated to find the values of the coefficients a₁ and a₂ resulting in the minimum squared value of e summed over the entire 150 points in the selected time segment. In this manner, the autoregressive model can be fitted to the time-series torque command data for the selected time segment.

Returning to FIG. 2, a graph 250 (below the block 240) displays the results of the autoregressive model fitting. The graph 250 includes a data trace for the original time-series torque command data for the selected time segment (from the graph 230), and also includes a plot of the autoregressive model fitted torque command data. For this data set, which was from a data collection window early in the service life of the robot, the autoregressive model fitted torque command data lies very closely on top of the original time-series torque command data trace, indicating a good fit of the second-order autoregressive model to the measured torque command data.

The theory embodied in the presently disclosed technique is that the signal of a healthy machine (e.g., the torque command signal of a healthy robot joint) is smooth and well-behaved, and can be well-represented by a low-order autoregressive model (as observed in the graph 250). Conversely, the signal of a machine with a developing defect is not as smooth and is not as well-fitted by a low-order autoregressive model. Examples of ill-fitting data will be shown in later figures and discussed below.

Returning again to FIG. 2, following the autoregressive model fitting at the block 240, an error calculation is performed at the block 260. The error calculation at the block 260 yields a numerical error value which represents the magnitude of the error in the autoregressive model fitting of the torque command data for a particular data set. In a preferred embodiment, the error calculation at the block 260 is performed with a square root of the sum of the squares computation on the value of e (the stochastic “error” term) for all of the time steps. That is, from Equations (2)-(4) (and all of the other equations in the set), with the values of the coefficients a₁ and a₂ now known, the value of e is determined for each time step, and the square root of the sum of the squares of all of the values of e is calculated; this is the resulting error value at the block 260.

At a block 270, it is determined whether to issue an alarm based on the error value calculated at the block 260. In a preferred embodiment, the error value from the block 260 is compared to a threshold value, and an alarm is issued if the calculated error value exceeds the threshold. The action taken at the block 270 can be defined to suit application requirements. That is, when the threshold is exceeded, the “alarm” could literally be an audible and visual alarm at the robot control station, or the “alarm” could be a visual indicator on a controller monitor, an email or push notification to a system operator or plant manager, a combination of these actions, or other actions as appropriate. The point is that a calculated error value exceeding the threshold is an indication that an anomaly has been detected in the torque command data, and although the anomaly is an early indicator of a developing problem, the robot needs attention. The system could also be configured so that the alarm is triggered by a pattern of repeated instances of the error value exceeding a threshold.

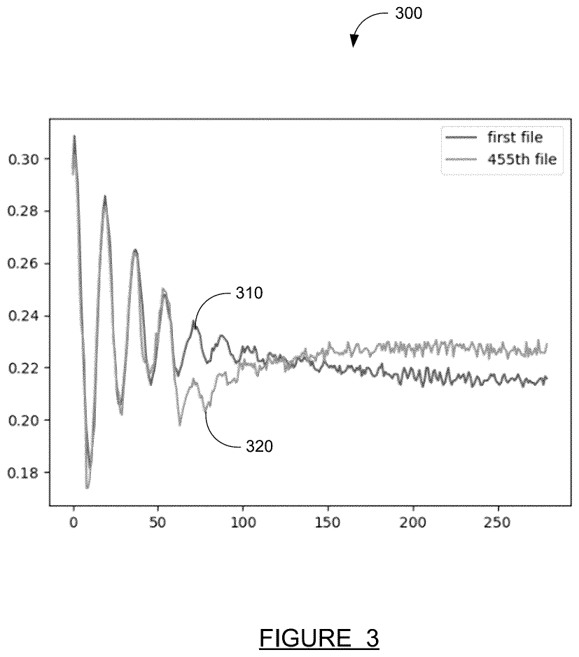

FIG. 3 is a graph 300 of robot joint torque command data versus time for a selected time segment of an operation exhibiting normal conditions and robot joint torque command data for a selected time segment of an operation exhibiting anomalous conditions, according to embodiments of the present disclosure. A data trace 310 plots the torque command data versus time in normal conditions. The data for the trace 310 was collected at the first data collection time window (i.e., cumulative robot operating time=2 hours) after the robot was placed into service. A data trace 320 plots the torque command data versus time in anomalous conditions. The data for the trace 320 was collected at the 455th data collection time window (i.e., cumulative robot operating time >900 hours) after the robot was placed into service.

It is apparent on the graph 300 that the data trace 320 has a significantly different shape than the data trace 310. The impact of this on the autoregressive model fitting and the resultant calculation of the error value are discussed further below.

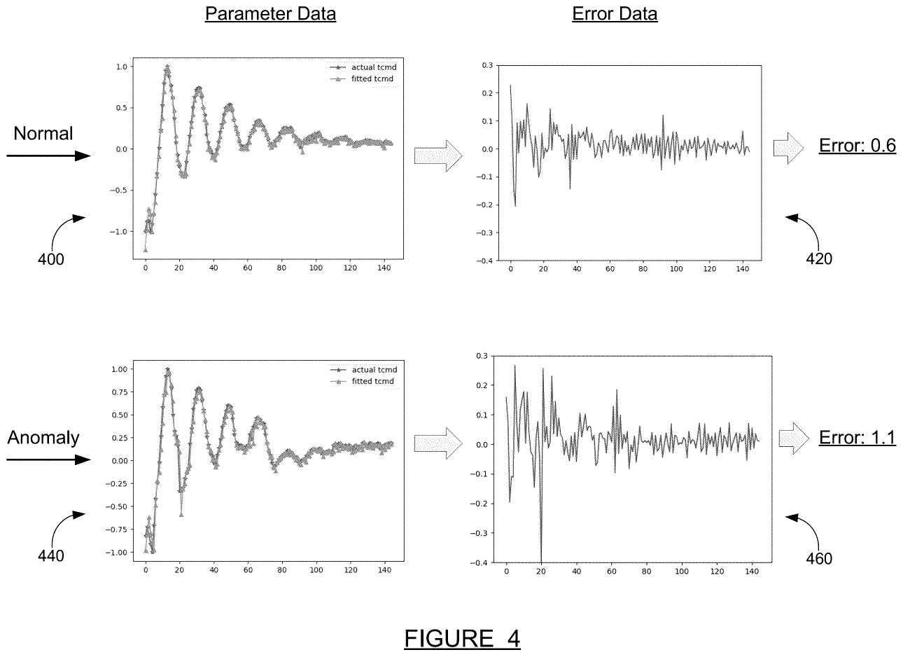

FIG. 4 is a set of graphs plotting measured torque command data and autoregressive model fitted data versus time, along with the corresponding error data versus time, for both normal and anomaly conditions of a robot, according to embodiments of the present disclosure. A graph 400 includes a data trace for the original measured time-series torque command data for the selected time segment, and also includes a plot of the autoregressive model fitted torque command data. These are the same as on the graph 250 of FIG. 2. As discussed earlier, for this data set, which was from a data collection window early in the service life of the robot, the autoregressive model fitted torque command data lies very closely on top of the original time-series torque command data trace, indicating a good fit of the second-order autoregressive model to the measured torque command data. Thus, the graph 400 indicates normal operating conditions of the robot joint.

A graph 420 plots the error data for the autoregressive model fitting data points of the graph 400. That is, following the autoregressive model fitting, with the values of the coefficients a₁ and a₂ now known, the values of e are determined for each time step, and this is the data that is plotted on the graph 420. When the error value for the operation is calculated, at the block 260 of FIG. 2 as described earlier, the resulting autoregressive model fitting error for the graph 420 has a value of 0.6, which is within the normal range.

A graph 440 includes a data trace for measured time-series torque command data for a selected time segment, and a plot of the autoregressive model fitted torque command data, for an anomalous robotic operation. The measured torque command data on the graph 440 is the same as the data trace 320 which was shown on the graph 300 of FIG. 3. As discussed earlier, this data set was from a data collection window over 900 hours later in the service life of the robot. In this case, the autoregressive model fitted torque command data has several noticeable outlier points, and generally does not lie as closely on top of the measured time-series torque command data trace. This indicates a poorer fit of the second-order autoregressive model to the measured torque command data, as compared to the graph 400 above.

A graph 460 plots the error data for the autoregressive model fitting data points of the graph 440. It is apparent that the error data on the graph 460 is generally of greater magnitude, with some data points much greater, when compared to the graph 420 above. When the error value for the operation is calculated, the resulting autoregressive model fitting error for the graph 460 has a value of 1.1, which is above the threshold of the normal range. Thus, the graphs 440 and 460 indicate an anomaly condition in the robot joint, and an alarm would therefore be issued.

To restate what was described earlier-data is collected for one or more robot operations at periodic timeframes through the robot's service life-such as every two hours of robot operation. In embodiments where an individual robot performs multiple operations, measurement data is preferably collected for each of the operations at each measurement time window. For articulated robots, the measured data preferably includes joint torque command data and joint speed versus time, for each operation, for one or more joints. For each collected set of input data (torque command and joint speed data versus time), the time-series data segmentation is performed to select a time range of interest, and the autoregressive model fitting is performed on the torque command data. The error data is then analyzed to determine whether an anomaly is indicated. These steps are performed automatically throughout the robot's service life, until eventually an anomaly is detected by way of error values exceeding the threshold and issuance of an alarm. At that point or soon thereafter, the robot may be taken offline for inspection and/or maintenance.

Experimental evaluations have shown that the disclosed techniques are very effective for anomaly detection in robotic joint data. The autoregressive model fitting techniques were applied to data files from several different robotic operations, where the data files were collected at two-hour intervals throughout the robot's service life as described above. For each different operation, the autoregressive model fitting techniques detected a significant increase in the error value at the same time in the robot's service life (at a measurement taken at over 900 hours of operation). Furthermore, the same threshold value (0.95) was found to be applicable to evaluation of the error value for all of the operations. In addition, alarms issued by the autoregressive model fitting anomaly detection technique were found to be early indications of actual joint deterioration that later lead to a joint component failure, thus providing validation of the effectiveness of the technique.

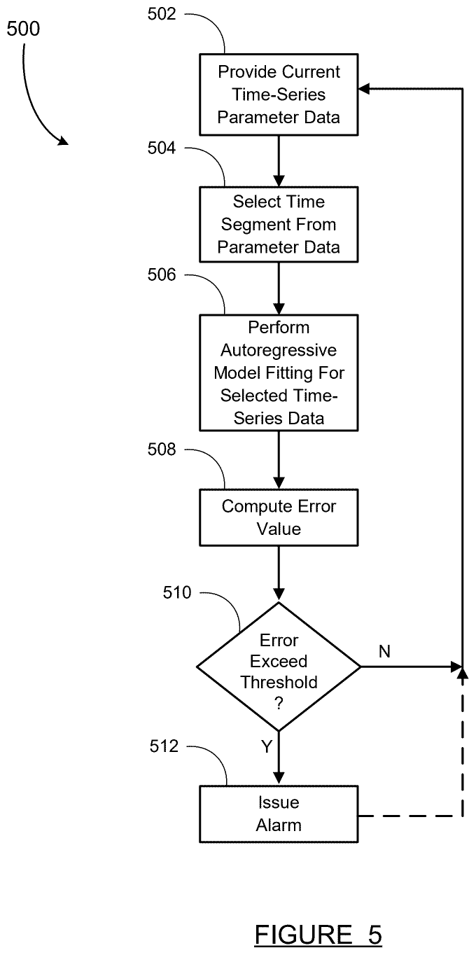

FIG. 5 is a flowchart diagram 500 of a method for anomaly detection in time-series data from a machine operation, including using autoregressive model fitting applied to segmented data along with subsequent analytic computations, according to embodiments of the present disclosure.

At box 502, current time-series data for parameters collected during one of the operations by the machine is provided. In the example discussed throughout the present disclosure, the current time-series data includes torque command and joint speed parameters for a robot joint, for any one of the operations performed by the robot. The current data is collected during one of the measurement windows (e.g., every two hours) during the operational service life of the robot.

At box 504, the current time-series parameter data is segmented to select only a time range of interest for further processing. For robot joint data, this is done by defining a time range which begins when the joint speed has settled down to essentially zero (below a prescribed amplitude threshold) and ends at some time after the torque command values have settled down to a very small amplitude (also below a prescribed threshold). This segmentation technique was discussed earlier with respect to FIG. 2. With the time range of interest defined, the torque command time-series data for the defined time range is selected for further processing.

At box 506, autoregressive model fitting is performed on the selected time-series data, which is the torque command parameter data for the time range of interest. The autoregressive model fitting includes selecting a model order (where an order of two has been found to be a preferred embodiment), defining equations relating the parameter value at each time step to a linear combination of (e.g., two) previous time steps, and performing a regression calculation to determine the values of the coefficients in the model which result in the lowest overall model error.

At box 508, a numerical error value is computed for the current time-series parameter data. This includes calculating the stochastic error term e for each time step of the autoregressive model, given the values of the coefficients a₂ and a₂, and then calculating the error value for the current parameter data, such as by calculating the square root of the sum of the squares of e for all of the time steps. As discussed earlier, the error calculation as the box 508 yields a single numerical value indicating how well the autoregressive model fits the time-series parameter data.

At decision diamond 510, it is determined whether the error value from the box 508 exceeds a predefined threshold. As discussed earlier, the presently disclosed technique applied to robot joint data yields error values which reliably stay within a certain range while the robot is performing normally, and the error values jump dramatically higher when anomalous behavior begins. Thus, selection of the threshold is a straightforward proposition. In a preferred embodiment, the threshold is set to a value of 0.95. This of course is application dependent.

If the error value does not exceed the threshold, then the process returns from the decision diamond 510 to the box 502 to process another set of parameter data-either for a different robot joint, or a different operation at the current measurement time window, or at a next measurement time window, for example.

If the error value exceeds the threshold, then at box 512 an alarm is issued. The “alarm” could include many different forms of alerts and/or notifications of anomalous behavior, as discussed earlier. The alarm trigger may also be defined based on the error value repeatedly exceeding a prescribed threshold. If the system is configured so that robotic operation may continue after the alarm is issued, then the process returns to the box 502 to process another set of parameter data, as indicated by the dashed line.

When an alarm is issued at the box 512, the robot will be evaluated, and at some point will be taken offline or out of service in order to perform further diagnostics or servicing. It is extremely advantageous to take the robot out of service in an orderly fashion and perform diagnosis and maintenance before a component fails—as a component failure may result in damage to other robot components and/or workpieces, and unscheduled downtime. The early warning issued by the disclosed autoregressive model fitting anomaly detection technique provides this advantage.

As discussed above, the disclosed autoregressive model fitting anomaly detection technique identifies anomalies in machine operation before conditions deteriorate to the point of failure. This, along with the fact that the technique can be applied to parameter data from any machine operation, with no model training needed, provides significant advantage to robot operators using the disclosed methods and systems.

Throughout the preceding discussion, various computers are described and implied. It is to be understood that the software applications and modules of these computers are executed on one or more computing devices having a processor and a memory module. In particular, this includes computer(s) with processor(s) configured with algorithms performing the autoregressive model fitting anomaly detection functions of FIGS. 2 and 5. These computational algorithm may run on the robot controller 120 itself (or any machine controller for other types of machines), or on a separate computer which is in communication with the controller and receives the operational parameter time-series data.

The foregoing discussion discloses and describes merely exemplary embodiments of the present disclosure. One skilled in the art will readily recognize from such discussion and from the accompanying drawings and claims that various changes, modifications and variations can be made therein without departing from the spirit and scope of the disclosure as defined in the following claims.

What is claimed is:

1. A computer-implemented method for anomaly detection in time-series data from a machine, said method comprising:
providing time-series data for parameters collected during an operation by the machine;
segmenting the time-series data to retain segmented time-series data from a time range of interest;
fitting an autoregressive model to the segmented time-series data for one of the parameters;
calculating an error term for each time step of the autoregressive model;
calculating an error metric based on the error term for all of the time steps; and
issuing an alert when the error metric has a value exceeding a predefined threshold.

2. The method according to claim 1 wherein providing time-series data is performed for a plurality of different operations performed by the machine at each of a plurality of measurement windows occurring periodically through a service life of the machine.

3. The method according to claim 1 wherein the machine is an industrial robot and the parameters include rotational velocity and torque command for a joint in the robot.

4. The method according to claim 1 wherein segmenting the time-series data includes identifying a start time at which values for a first one of the parameters have dropped below a first threshold amplitude, and retaining the segmented time-series data for a second one of the parameters beginning at the start time.

5. The method according to claim 4 further comprising truncating the segmented time-series data to end at an end time at which values for the second one of the parameters have dropped below a second threshold amplitude.

6. The method according to claim 1 wherein fitting an autoregressive model to the segmented time-series data includes defining an order of the autoregressive model as a number in a range of one to three, formulating a set of equations relating a value of the parameter at each time step to a linear combination of values of the parameter at the number of previous time steps plus a stochastic term, and solving for values of coefficients used in the equations.

7. The method according to claim 6 wherein solving for values of coefficients used in the equations includes using a least-squares regression to determine the values of the coefficients which minimize the stochastic term.

8. The method according to claim 6 wherein calculating an error term for each time step of the autoregressive model includes solving the equations for the stochastic term at each time step using the values of the coefficients, and setting the error term for each time step equal to the stochastic term.

9. The method according to claim 1 wherein calculating an error metric includes calculating the error metric as a square root of a sum of the squares of the error terms for all of the time steps.

10. The method according to claim 1 wherein issuing an alert includes one or more of triggering audible and/or visual alarms in a vicinity of the machine, displaying a message on an operating console of the machine, and sending an electronic message to one or more persons indicating that anomalous conditions have been detected in the machine.

11. A computer-implemented method for anomaly detection in time-series data from a robot, said method comprising:
providing time-series data for parameters collected during an operation by the robot, where the parameters include a rotational velocity and a torque command for a joint of the robot;
segmenting the time-series data to retain segmented time-series data from a time range of interest beginning when values of the rotational velocity have dropped below a first threshold amplitude and ending when values of the torque command have dropped below a second threshold amplitude;
fitting an autoregressive model to the segmented time-series data for the torque command, including defining an order of the autoregressive model as two, formulating a set of equations relating a value of the torque command at each time step to a linear combination of values of the torque command at two previous time steps plus a stochastic term, and using a least-squares regression to determine values of coefficients used in the equations which minimize the stochastic term;
setting an error term equal to the stochastic term for each time step of the autoregressive model;
calculating an error metric as a square root of a sum of the squares of the error term for all of the time steps; and
issuing an alert when the error metric has a value exceeding a predefined threshold.

12. A time-series anomaly detection system, said system comprising:
a computer having a processor and memory configured to perform steps including;
receiving time-series data for parameters collected during an operation by a machine;
segmenting the time-series data to retain segmented time-series data from a time range of interest;
fitting an autoregressive model to the segmented time-series data for one of the parameters;
calculating an error term for each time step of the autoregressive model;
calculating an error metric based on the error term for all of the time steps; and
issuing an alert when the error metric has a value exceeding a predefined threshold.

13. The system according to claim 12 wherein receiving time-series data is performed for a plurality of different operations performed by the machine at each of a plurality of measurement windows occurring periodically through a service life of the machine.

14. The system according to claim 12 wherein segmenting the time-series data includes identifying a start time at which values for a first one of the parameters have dropped below a first threshold amplitude, identifying an end time at which values for a second one of the parameters have dropped below a second threshold amplitude, and retaining the segmented time-series data for the second one of the parameters for the time range of interest spanning from the start time to the end time.

15. The system according to claim 12 wherein fitting an autoregressive model to the segmented time-series data includes defining an order of the autoregressive model as a number in a range of one to three, formulating a set of equations relating a value of the parameter at each time step to a linear combination of values of the parameter at the number of previous time steps plus a stochastic term, and solving for values of coefficients used in the equations.

16. The system according to claim 15 wherein solving for values of coefficients used in the equations includes using a least-squares regression to determine the values of the coefficients which minimize the stochastic term.

17. The system according to claim 15 wherein calculating an error term for each time step of the autoregressive model includes solving the equations for the stochastic term at each time step using the values of the coefficients, and setting the error term for each time step equal to the stochastic term.

18. The system according to claim 12 wherein calculating an error metric includes calculating the error metric as a square root of a sum of the squares of the error terms for all of the time steps.

19. The system according to claim 12 wherein issuing an alert includes one or more of triggering audible and/or visual alarms in a vicinity of the machine, displaying a message on an operating console of the machine, and sending an electronic message to one or more persons indicating that anomalous conditions have been detected in the machine.

20. The system according to claim 12 further comprising the machine, the machine being an industrial robot, and where the parameters include rotational velocity and torque command for a joint in the robot.
